(19) United States
(12) Patent Application Publication
(10) Pub. No.: US 2013/0129210 A1
(43) Pub. Date: May 23, 2013

(54) RECOMMENDATION SYSTEM BASED ON THE RECOGNITION OF A FACE AND STYLE, AND METHOD THEREOF

(71) Applicant: Seung Won Na, Seoul (KR)

(72) Inventor: Seung Won Na, Seoul (KR)

(73) Assignee: SK PLANET CO., LTD., Seoul (KR)

(21) Appl. No.: 13/813,003

(22) PCT Filed: Jul. 15, 2011
(86) PCT No.: PCT/KR2011/005210

§ 371 Date: Jan. 29, 2013

(30) Foreign Application Priority Data
Nov. 2, 2010 (KR) 10-2010-0108441
Nov. 2, 2010 (KR) 10-2010-0108442

(51) Int. Cl. G06K 9/00

(52) U.S. Cl. CPC G06K 9/00268
USPC 382/165; 382/195

(57) ABSTRACT

The present disclosure relates to a recommendation system based on the recognition of a face and style, and method thereof. More particularly, face and style feature information is extracted from a user image, face and style characteristics are recognized from the extracted face and style feature information, and then recommendation style information (for example, a hair style, a make-up style, product information, or the like) matched with the recognized face and style characteristics is searched in a recommendation style table templated in advance according to characteristics to thereby be recommend, such that recommendation style information most appropriately matched with user's face and style may be rapidly and easily recommended.

### TECHNICAL FIELD

The present disclosure relates to a recommendation system based on the recognition of a face and style, and method thereof, and more particularly, to a recommendation system based on the recognition of a face and style, and method thereof capable of rapidly and easily recommending recommendation style information most appropriately matched with a user's face and style by extracting face and style feature information from a user image, recognizing face and style characteristics from the extracted face and style feature information, and then searching recommendation style information (for example, a hair style, a make-up style, product information, or the like) matched with the recognized face and style characteristics in a recommendation style table templated in advance according to characteristics to recommend the searched recommendation style information.

### BACKGROUND ART

Together with rapid increase of distribution of the portable phone, a portable terminal with various functions has been on the market. The portable terminal conveniently provides various additional functions to a user in addition to generally calling the other party.

For example, the user wirelessly accesses the internet using a wireless Internet technology to thereby receive a multimedia data service such as a message, an image, a voice, a moving picture, or the like, as well as performing voice communications while carrying the portable phone. As an additional function provided in the portable phone, there are music player, a short message service, a wireless messenger, mobile banking, fingerprint recognition for authenticating a user, a camera function, or the like.

Gradually, the mobile phone departs from an initial mobile phone for voice communication through a camera included in order to use these multimedia services to evolve into a smart phone having various functions such as a media player, a camera, a camcorder, or the like. The moving picture photographed using the camcorder function as described above is also transmitted to another terminal.

Particularly, together with the smart phone craze, a face recognition technology has been mounted in the smart phone. It is predicted that an application technology using the face recognition technology will be widely spread. The face recognition technology, which is a kind of bio recognition technologies, is a non-contact recognition technology providing user's convenience unlike contact iris recognition and fingerprint recognition and is applied to various devices.

Meanwhile, a virtual experience service, or the like, in which the user may previously experience a dress, a hair style, product information, or the like, that is suitable for him, before visiting a store, has been developed. The user checks a size or a color in advance in the shopping mall site of the corresponding product to confirm whether the product is suitable for the user. The user may virtually experience the size or the color of the corresponding product. In the virtual experience service according to the related art, a virtual image corresponding to clothes or a hair style selected by the user may be inserted in an actual image, and an actual image having the inserted virtual image may be provided to the user. Therefore, the user may compare various clothes. This virtual experience service may save time of the user.

In the virtual experience service according to the related art, the user may select a style one by one from a lot of virtual styles and confirm whether it is suitable for a size or a taste of the user, but since the user selects so many styles one by one, a considerable amount of time or effort for searching a style suitable for the user is consumed. In the virtual experience service according to the related art, the more the styles are capable of being compared, the more difficult it is to search the style or the product information suitable for a user.

### DISCLOSURE

### Technical Problem

The present disclosure is contrived to solve the above-mentioned problems, and an object of the present disclosure is to provide a recommendation system based on the recognition of a face and style, and method thereof capable of rapidly and easily recommending recommendation style information most appropriately matched with a user face and style by extracting face and style feature information from a user image, recognizing a face and style characteristics from the extracted face and style feature information, and then searching recommendation style information (for example, a hair style, a make-up style, product information, or the like) matched with the recognized face and style characteristics in a recommendation style table templated in advance according to characteristics to recommend the searched recommendation style information.

### Technical Solution

To this end, a recommendation system based on the recognition of a face and style according to a first aspect of the present disclosure includes: a user terminal transmitting a user image through a communication network or extracting face and style feature information from the user image to transmit the extracted face and style feature information through the communication network; and a recommendation device templating recommendation style information matched with face and style characteristics to generate a recommendation style table, recognizing the face and style characteristics from the user image transmitted from the user terminal or the face and style feature information transmitted from the user terminal, and searching recommendation style information matched with the recognized face and style characteristics in the generated recommendation style table to transmit the searched recommendation style information to the user terminal.

Meanwhile, a recommendation device based on the recognition of face and style according to a second aspect of the present disclosure includes: a face recognition unit extracting face feature information from a user image transmitted from a user terminal and recognizing face characteristics using the extracted face feature information, or recognizing the face characteristics using face feature information transmitted from the user terminal; a style recognition unit extracting style feature information from the transmitted user image and recognizing style characteristics using the extracted style feature information, or recognizing the style characteristics using style feature information transmitted from the user terminal; and a recommendation unit searching recommendation style information matched with the recognized face and style characteristics in a recommendation style table in which recommendation style information is templated according to face and style characteristics to transmit the searched recommendation style information to the user terminal.

A product recommendation method based on the recognition of face and style according to a third aspect of the present disclosure includes: an information extracting step of extracting face and style feature information using a user image; a face recognizing step of recognizing face characteristics using the extracted face feature information; a style recognizing step of recognizing style characteristics from the extracted style feature information; and a style recommending step of searching recommendation style information matched with the recognized characteristics and style characteristics in a recommendation style table in which recommendation style information is templated according to characteristics to transmit the searched recommendation style information to a user terminal.

### Advantageous Effects

As set forth above, according to the present disclosure, face and style feature information is extracted from a user image, face and style characteristics are recognized from the extracted face and style feature information, and then recommendation style information matched with the recognized characteristics and style characteristics is searched in a recommendation style information templated in advance according to characteristics to thereby be recommend, such that the recommendation style information most appropriately matched with a user's face and style may be rapidly and easily recommended.

More particularly, according to the present disclosure, hair style information matched with the recognized face and style characteristics is searched in the hair style information learned in advance according to face characteristics and be recommended, such that a hair style most appropriately matched with the user's face may be rapidly and easily recommended.

In addition, according to the present disclosure, the face and style characteristics are recognized by gender and age related with hair recommendation and user's hair style preferences as well as face feature points, a forehead length, and a hair length, extracted from the user image, such that the hair style more appropriate for the user may be recommended.

Further, according to the present disclosure, the recommendation style result recommended through the user image is templated as new recommendation style information according to characteristics, such that a database of the recommendation style information may be easily constructed and more accurate recommendation style information may be recommended based on product recommendation result of other users.

Furthermore, according to the present disclosure, the style information related with the product recommendation and the product style preference of the user as well as the face feature point information extracted from the user image are reflected in the product recommendation process, such that a product style more appropriate for the user may be recommended.

### DESCRIPTION OF DRAWINGS

FIG. 1 is a configuration diagram of a recommendation system based on the recognition of face and style according to an exemplary embodiment of the present disclosure.

FIG. 2 is a diagram for explaining a process of templating recommendation style information and a process of recommending a product according to an exemplary embodiment of the present disclosure.

FIG. 3 is a diagram for explaining a process of recognizing face and style characteristics in a recommendation device according to an exemplary embodiment of the present disclosure.

FIG. 4 is a diagram for explaining a process of recommending a hair style according to an exemplary embodiment of the present disclosure.

FIG. 5 is a flow chart for a product recommendation method based on the recognition of face and style according to a first exemplary embodiment of the present disclosure.

FIG. 6 is a flow chart for the product recommendation method based on the recognition of face and style according to a second exemplary embodiment of the present disclosure.

### BEST MODE

Hereinafter, exemplary embodiments of the present disclosure will be described in detail with reference to the accompanying drawings. The configuration and the operation effects of the present disclosure will be clearly understood by the following detailed description. Prior to a description of the present disclosure, It is be noted that like reference numerals designate like components even though the components are shown in different drawings, and when a description of well-known configuration make unclear the spirit of the present disclosure, a detailed description thereof will be omitted.

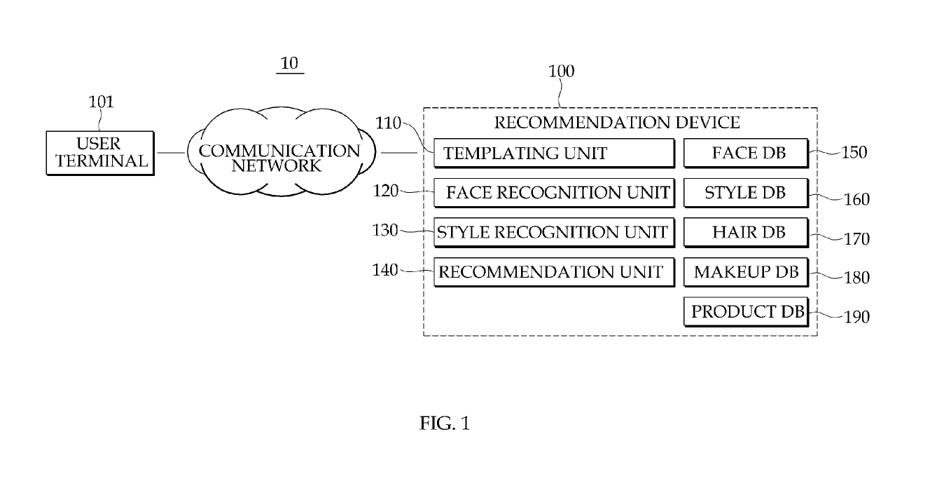

FIG. 1 is a configuration diagram of a recommendation system based on the recognition of face and style according to an exemplary embodiment of the present disclosure.

As shown in FIG. 1, the recommendation system 10 includes a user terminal 101 and a recommendation device 100. Here, the recommendation device 100 includes a templating unit 110, a face recognition unit 120, a style recognition unit 130, a recommendation unit 140, a face database (DB) 150, a style DB 160, a hair DB 170, a makeup DB 180, and a product DB 190.

Hereinafter, each of the components of the recommendation system 10 based on the recognition of face and style according to the exemplary embodiment of the present disclosure will be described.

The user terminal 100 transmits a user image though a communication network, or extracts face feature information (for example, face feature point information, a skin color, wrinkles information, a mouth shape, an eye shape, a middle of the forehead, a nose size, a forehead width, and the like) and style feature information (for example, color information, apparel pattern information, season information, weather information, time information, and the like) from the user image to transmit the extracted face and style feature information through the communication network.

As a first exemplary embodiment of the user terminal 101, the user terminal 101 transmits 101 the user image to the recommendation device 100 through the communication network. The user terminal 101 may be a computer, a mobile phone, or a smart phone, including an image photographing module, but is not limited thereto. The user terminal 101 photographs the image of the user using the included image photographing module to obtain the user image. Here, the image photographing module may be a camera connected to an external control device such as the computer, or the like, a webcam, or a camera embedded in a personal digital assistance.

As a second exemplary embodiment of the user terminal 101, the user terminal 101 detects a face region of the user from the actual image obtained by the image photographing module and extracts face feature information from the detected face region. In addition, the user terminal 101 detects a user style region rather than the user's face region from the actual image and extracts style feature information from the detected user style region. Next, the user terminal 101 transmits the extracted face and style feature information to the recommendation device 100 through the communication network. Here, face feature point information for a main portion of the face such as the eyes, nose, mouth, face outline, and the like, a forehead length, and a length between a forehead and a head are included in the face feature information. In addition, the skin color, the wrinkle information, the mouth shape, the eye shape, a brow shape, the middle of the forehead, a nose shape, and the like may be included in the face feature information. In addition, the color information, the apparel pattern information, the season information, the weather information, indoor/outdoor information, time information, and the like may be included in the style feature information.

The user terminal 101 may reduce or enlarge the actual image corresponding to a preset face region size before detecting the face or user style region. This process of reducing and enlarging the actual image assists the user terminal 101 in accurately detecting the face region and then detecting face feature points.

As a first exemplary embodiment of the recommendation device 100, the recommendation device 100 templates the recommendation style information according to characteristics through the face and style feature information collected in advance or simulated to generate a recommendation style table. In addition, the recommendation device 100 receives the user image from the user terminal 101 and extracts the face and style feature information from the received user image. Next, the recommendation device 100 recognizes the face and style characteristics using the extracted face and style feature information.

As a second exemplary embodiment of the recommendation device 100, the recommendation device 100 receives the face and style feature information rather than the user image from the user terminal 101 and recognizes the face and style characteristics from the received face and style feature information.

Then, the recommendation devices 100 according to the first and second exemplary embodiments search recommendation style information for characteristics matched with the recognized face and style characteristics in the recommendation style table. In addition, the recommendation device 100 transmits the searched recommendation style information to the user terminal 101. Here, at least one of hair style information, makeup style information, and recommendation product information is included in the recommendation style information.

Meanwhile, each of the components of the recommendation device 100 will be described below.

The templating unit 110 analyzes the face and style feature information collected in advance or simulated and the recommendation style information corresponding thereto, and templates the recommendation style information according to characteristics to thereby generate the recommendation style table. The templating unit 110 stores the recommendation style information templated according to characteristics in a corresponding DB among the hair DB 170, the makeup DB 180, and the product DB 190. After the recommendation of the style is completed, the templating unit 110 matches the recognized face and style feature information with recommendation style information searched in the recommendation unit 140. Further, the templating unit 110 templates the matched result as new recommendation style information according to characteristics to store in a corresponding DB among the hair DB 170, the makeup DB 180, and the product DB 190. Therefore, new recommendation style information may be templated to thereby be stored in the hair DB 170, the makeup DB 180, and the product DB 190.

The face recognition unit 120 extracts the face feature information from the user image transmitted from the user terminal 101 and recognizes the face characteristics using the extracted face feature information. The face recognition unit 120 extracts the face feature information including the face feature point information, the skin color, the wrinkle information, the nose size, the forehead width, and the like, from the user image transmitted from the user terminal 101. The face recognition unit 120 recognizes the face characteristics using the extracted face feature information including the face feature point information, the skin color, the wrinkle information, the nose size, the forehead width, and the like.

Reviewing the face characteristics, the face recognition unit 120 may separate and recognize the user into male/female and people in their 10s, 20s, 40s, or the like, according to gender and age. The face recognition unit 120 recognizes the face characteristics using the matched result between the face feature information stored in the face DB 150 and the face characteristics. Here, the face characteristics may include the gender and the age required for style recommendation, and further include the entire face characteristics. The face recognition unit 120 stores the face feature information extracted from the user image and the recognized face characteristics in the face DB 150.

The style recognition unit 130 extracts the style feature information from the user image transmitted from the user terminal 101 and recognizes the style characteristics using the extracted style feature information. The style recognition unit 130 extracts the style feature information including the color information, the apparel pattern information, the season information, the weather information, the indoor/outdoor information, and the time information from the user image transmitted from the user terminal 101. That is, the style recognition unit 130 recognizes the style characteristics using the extracted style feature information including the color information, the apparel pattern information, the season information, the weather information, the indoor/outdoor information, and the time information.

Viewing the style characteristics, the style recognition unit 130 may separate the user image into a beige color, a formal style, a summer, shine, out door, afternoon, and the like to recognize a cool formal style from the style feature information. The style recognition unit 130 recognizes the style characteristics using the matched result between the style feature information stored in the face DB 150 and the style characteristics. Here, for style recommendation, the color information, the apparel pattern information, the season information, the weather information, the indoor/outdoor information, and the time information may be included in the style characteristics. The style recognition unit 130 stores the style feature information extracted from the user image and the recognized style characteristics in the style DB 160.

The recommendation unit 140 searches the recommendation style information for the characteristics matched with the face and style characteristics recognized in the face recognition unit 120 in the recommendation style table. The recommendation unit 140 may receive a style preference from the user terminal 101 and search the recommendation style information matched with the received style preference, the face and the style characteristics. The recommendation unit 140 transmits the searched recommendation style information to the user terminal 101. In the case in which a plurality of recommendation style information is searched, the recommendation unit 140 may prioritize the plurality of searched recommendation style information according to a matched ratio with the characteristics to transmit it to the user terminal 101. For example, in the case in which a plurality of style has a matched ratio higher than a specific ratio, the recommendation unit 140 may indicate and transmit the matched ratio for each recommendation style information.

Meanwhile, as a third exemplary embodiment of the user terminal 101, the user terminal 101 may self-perform a series of processes of extracting the face and style feature information from the actual image, recognizing the face and style characteristics from the extracted feature information, and searching the recommendation style information matched with the recognized face and style characteristics.

To this end, the user terminal 101 includes a memory, a face recognizer, a style recognizer, and a recommender.

The memory stores a recommendation style table in which recommendation style information matched with face and style characteristics is templated.

In addition, the face recognizer includes a photographing module to photograph the user and extracts face feature information from the photographed user image. Further, the face recognizer recognizes the face characteristics using the extracted face feature information.

In addition, the style recognizer extracts style feature information from the photographed user image and recognizes style characteristics using the extracted style feature information.

Next, the recommender may search recommendation style information matched with the face and style characteristics recognized in the face recognizer and the style recognizer in the recommendation style table in which the recommendation style information is templated according to face and style characteristics stored in the memory to provide the searched recommendation style information to the user.

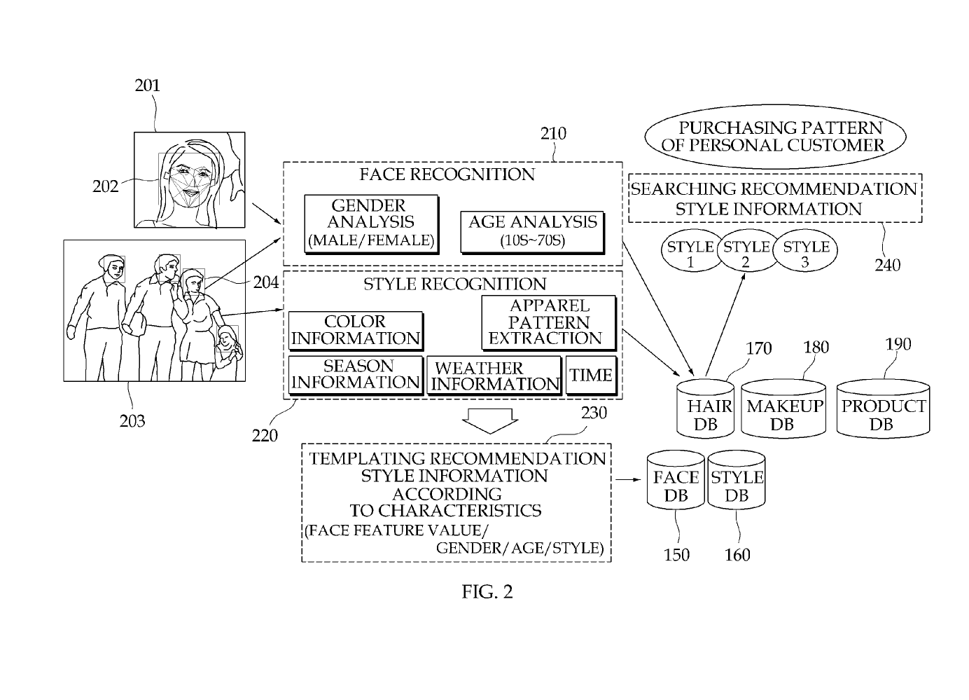

FIG. 2 is a diagram for explaining processes of templating the recommendation style information and recommending style according to an exemplary embodiment of the present disclosure.

As shown in FIG. 2, the process of recommending a style in the recommendation device 100 roughly includes a face recognizing process 210, a style recognizing process 220, a recommendation style information templating process 230 according to characteristics, and a recommendation style searching process 240.

In order to template the recommendation style, the recommendation device 100 performs the face recognizing process 210, the style recognizing process 220, and the recommendation style information templating process 230 according to the characteristics.

For the face recognizing process 210 and the style recognizing process 220, the recommendation device 100 detects a face region 202 from a user image 201 transmitted from a user terminal 101 and extracts face feature information from the detected face region 202. Next, the recommendation device 100 may recognize gender and age from the extracted face feature information. In addition, the recommendation device 100 may extract style feature information from a region of the user image 201 except for the face region 202 and recognize the user style characteristics from the extracted style feature information. The face feature information and face characteristics, and the style feature information and style characteristics are stored in the face DB 150 and the style DB 160, respectively.

For the recommendation style information templating process 230 according to the characteristics, the recommendation device 100 generates a recommendation style table using the recommendation style information matched with the recognized face and style characteristics to store the generated recommendation style table in a corresponding DB.

After the recommendation style information templating process 230 according to the characteristics, the recommendation device 100 performs the face recognizing process 210 and the style recognizing process 220 using newly input user images 203 and face regions 204 to recognize face and style characteristics.

Next, for the recommendation style information searching process 240, the recommendation device 100 searches the recommendation style information in the recommendation style table based on the recognized face and style characteristics. The recommendation device 100 may search the recommendation style information matched with the face and style characteristics in styles 1 to 3 included in the recommendation style table stored in the product DB 190. In addition, the recommendation device 100 may request an external style searching shopping mall to transmit the recommendation style information and receive the recommendation style information. Here, the user terminal 101 receives the style preference input from the user and transmits the input style preference to the recommendation device 10 to thereby request style recommendation. In the recommendation style information searching process 240, a purchasing pattern of a personal customer may be reflected.

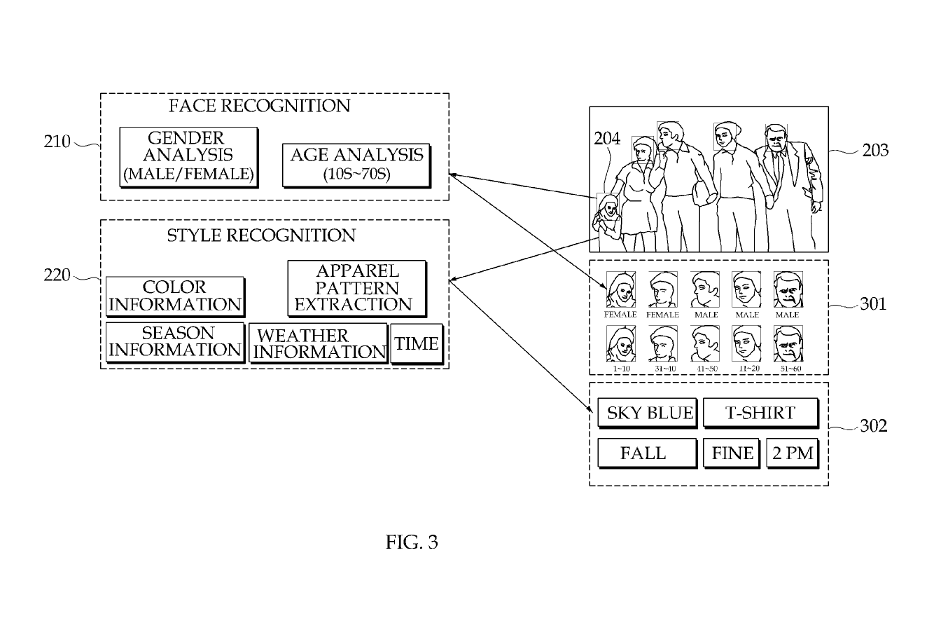

FIG. 3 is a diagram for explaining a process of recognizing face and style characteristics in a recommendation device according to an exemplary embodiment of the present disclosure

In the case in which new user images 203 are input, the face recognition unit 120 may analyze the gender (male/female) and the age through the face recognizing process 210. As shown in FIG. 3, the face recognition unit 120 may extract face feature information for each of the users from the user images 203 and analyze the gender and the age of each of the users from the extracted face feature information. As a result, the face recognition unit 120 may recognize the gender and the age of the user as the male user in his 10s, the female user in her 30s, and the female user in her 10s, or the like.

In addition, the style recognition unit 130 may extract style feature information of each of the user from a region of the user images 203 except for the face regions 204, thereby making it possible to recognize the style characteristics. As shown in FIG. 3, the style recognition unit 130 may extract the style feature information for the user who is male and 1-10 years old, that the color is sky blue, the apparel pattern is a T-shirt, the season is fall, the weather is fine, and it is 2 pm, and extracts the style characteristics for the teenager from the extracted style feature information.

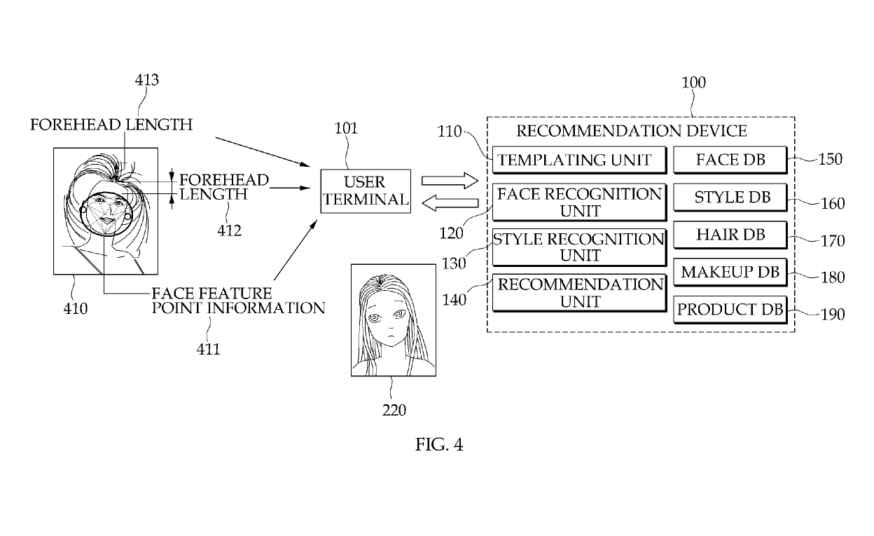

FIG. 4 is a diagram for explaining a process of recommending a hair style according to an exemplary embodiment of the present disclosure.

As shown in FIG. 4, the user terminal 101 extracts face feature point information 411, a forehead length 412, and a length between the forehead and a head 413 from a user image 410 photographed by the image photographing module or obtained from the outside. Here, the face feature point information 411, the forehead length 412, and the length between the forehead and the head 413 are information required to recommend a hair style and may be further include gender and age information of the user.

In addition, the user terminal 101 transmits the extracted face feature point information 411, the extracted forehead length 412, and the extracted length between the forehead and the head 413 to the recommendation device 100 to request hair style recommendation. In addition, the user terminal 101 may receive a hair style preference input from the user and transmit the input hair style preference to the recommendation device 100 to thereby request hair style recommendation.

Then, the recommendation device 100 searches hair style information matched with the face characteristics recognized in the face recognition unit 120 through the recommendation unit 140 and transmits the searched hair style information 420 to the user terminal 101 through the communication network, thereby recommending the hair style. Here, the hair style information 420 may be a hair style image in which only hair style is displayed, or be a virtual hair style experience image in which the hair style is inserted in the user image.

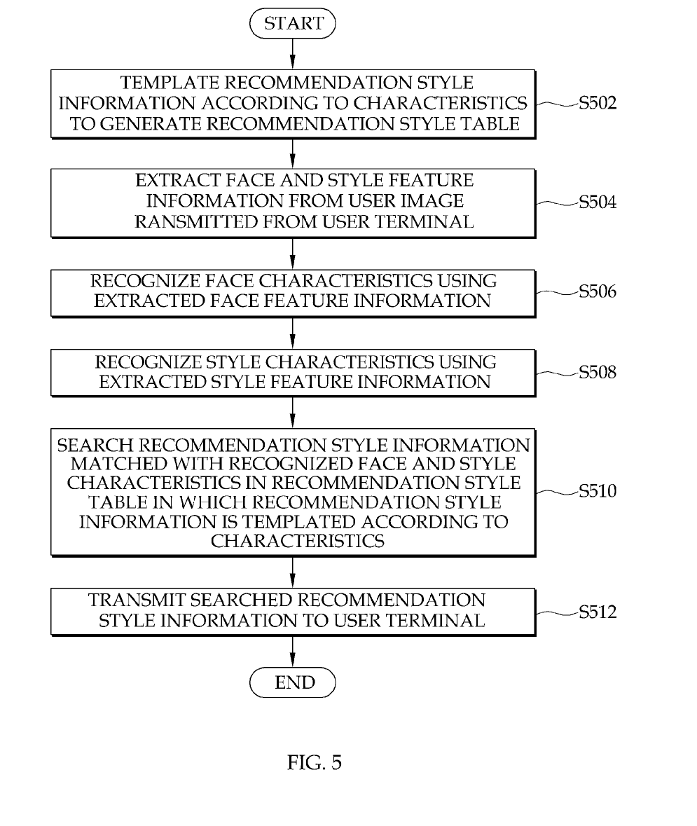

FIG. 5 is a flow chart for a recommendation method based on the recognition of face and style according to a first exemplary embodiment of the present disclosure.

A templating unit 110 analyzes face and style feature information and corresponding recommendation style information and templates recommendation style information according to characteristics, thereby generating a recommendation style table (S502). Here, the face and style feature information and the corresponding recommendation style information are templated to be generated as a recommendation style table and stored in a hair DB 170, a makeup DB 180, and a product DB 190, which are corresponding DBs.

In addition, the face and style recognition units 120 and 130 extract face feature information and style feature information from a user image transmitted from a user terminal 101, respectively (S504). For example, the face recognition unit 120 extracts the face feature information including face feature point information, a skin color, wrinkle information, and the like, from the user image transmitted from the user terminal 101. Further, the style recognition unit 130 extracts the style feature information including color information, apparel pattern information, season information, weather information, and the like, from the user image.

Then, the face recognition unit 120 recognizes face characteristics using the extracted face feature information (S506). The face recognition unit 120 recognizes the face characteristics using the face feature point information, a forehead length, and a length between the forehead and a head. The face recognition unit 120 may recognize gender and age from the extracted face feature information.

In addition, the style recognition unit 130 recognizes style characteristics using the extracted style feature information (S508). The style recognition unit 130 may recognize style characteristics using the extracted color information, the apparel pattern information, the season information, the weather information, and the like.

Then, the recommendation unit 140 searches the recommendation style information for the characteristics matched with the face and style characteristics recognized in the face recognition unit 120 and the style recognition unit 130 in the recommendation style table according to the characteristics generated in the “S502” process (S510). Here, at least one of the hair style information, makeup style information, and recommendation product information is included in the recommendation style information. The recommendation unit 140 may receive a style preference from the user terminal 101 and search the recommendation style information matched with the received style preference and the characteristics. Further, in the case in which a plurality of recommendation style information is searched, the recommendation unit 140 may prioritize the plurality of searched recommendation style information according to a matched ratio with the characteristics.

In addition, the recommendation unit 140 transmits the searched recommendation style information to the user terminal 101 (S512).

After recommendation of the product is completed, the templating unit 110 may match the characteristics recognized in the face and style recognition units 120 and 130 with the recommendation style information searched in recommendation unit 140 and template the matched result as new recommendation style information according to characteristics.

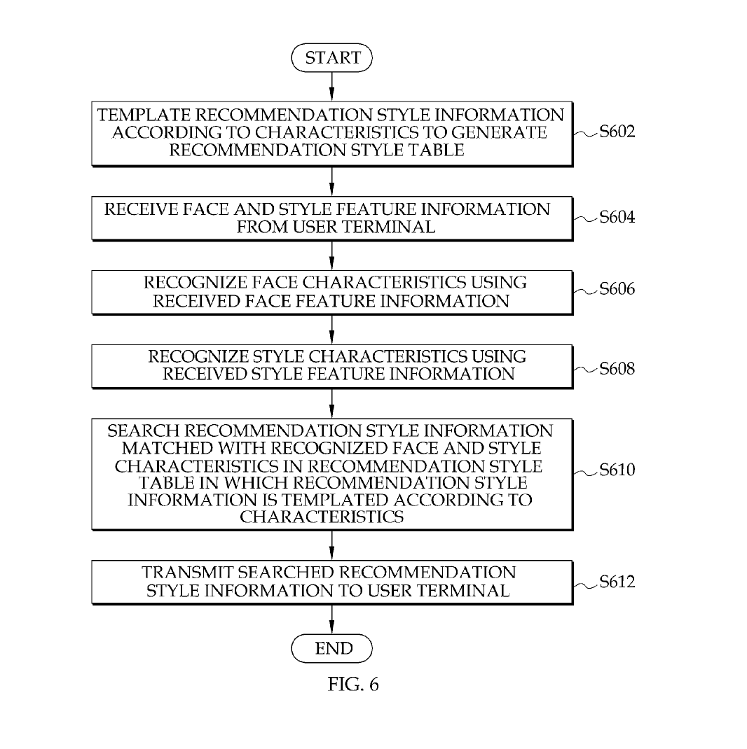

FIG. 6 is a flow chart for the recommendation method based on the recognition of face and style according to a second exemplary embodiment of the present disclosure.

The templating unit 110 analyzes recommendation style information matched with face and style characteristics to template recommendation style information according to characteristics (S 602). Here, the recommendation style information matched with the face and style feature information may be information collected in advance or simulated to thereby be stored in a product DB 190.

A user terminal 101 extracts face feature information including face feature point information, skin color, wrinkle information, and the like, from a user image photographed by an image photographing module to transmit the extracted information to a recommendation device 100. In addition, the user terminal 101 extracts style feature information including color information, apparel pattern information, season information, and the like, from the user image to transmit the extracted information to the recommendation device 100.

Then, a face recognition unit 120 receives the face and style feature information extracted in the user terminal 101 (S604).

In addition, the face recognition unit 120 recognizes face and style characteristics using the face feature information transmitted from the user terminal 101 (S606). The face recognition unit 120 recognizes the face characteristics using the face feature point information, a forehead length, and a length between the forehead and a head. The face recognition unit 120 may separate and recognize gender and age of a user.

In addition, the face recognition unit 130 recognizes style characteristics using the style feature information transmitted from the user terminal 101 (S608). The style recognition unit 130 recognizes the style characteristics using the style feature information including the color information, the apparel pattern information, the season information, and the like (S608).

Then, a recommendation unit 140 searches recommendation style information matched with the face and style characteristics recognized in the face and style recognition units 120 and 130 in a recommendation style table in which the recommendation style information is templated according to characteristics (S610).

In addition, the recommendation unit 140 transmits the searched recommendation style information to the user terminal 101 (S612).

After recommendation of the style is completed, the templating unit 110 may match the face and style characteristics with the recommendation style information searched in the recommendation unit 140 and template the matched result as new recommendation style information according to characteristics.

Meanwhile, a process of recommending a style matched with a user image photographed in the user terminal 101 without the communication network will be described below. That is, in the case in which the user terminal 101 independently performs a service without using a service based on the network, the user terminal 101 includes a face recognizer, a style recognizer, and a recommender and stores a recommendation style table in which recommendation style information matched with face and style characteristics is templated in an external memory or an embedded memory in advance.

The user terminal 101 photographs the user through the included photographing module.

In addition, the user terminal 101 extracts face feature information from the photographed user image. Further, the user terminal 101 recognizes face characteristics using the extracted face feature information.

In addition, the user terminal 101 extracts style feature information from the photographed user image and recognizes style characteristics using the extracted style feature information.

Next, the user terminal 101 may search recommendation style information matched with the face characteristics recognized in the face recognizer and the style recognizer in the recommendation style table in which the recommendation style information is templated according to face and style characteristics stored in the memory to provide the searched recommendation style information to the user.

The spirit of the present disclosure has been just exemplified above. It will be appreciated by those skilled in the art that various modifications can be made without departing from the essential characteristics of the present disclosure. Therefore, the present disclosure is not limited to the exemplary embodiments described in the specification of the present disclosure. The scope of the present disclosure must be analyzed by the appended claims and it should be understood that all spirits within a scope equivalent thereto are included in the appended claims of the present disclosure.

### INDUSTRIAL APPLICABILITY

As set forth above, according to the present disclosure, face and style feature information is extracted from a user image, face and style characteristics are recognized from the extracted face and style feature information, and then recommendation style information (for example, a hair style, a make-up style, product information, or the like) matched with the recognized face and style characteristics is searched in a recommendation style table templated in advance according to characteristics to thereby be recommend, such that recommendation style information most appropriately matched with the user's face and style may be rapidly and easily recommended.

1. A recommendation system based on the recognition of face and style, comprising:
a user terminal transmitting a user image through a communication network or extracting face and style feature information from the user image to transmit the extracted face and style feature information through the communication network; and
a recommendation device templating recommendation style information matched with face and style characteristics to generate a recommendation style table, recognizing the face and style characteristics from the user image transmitted from the user terminal or the face and style feature information transmitted from the user terminal, and searching recommendation style information matched with the recognized face and style characteristics in the generated recommendation style table to transmit the searched recommendation style information to the user terminal.

2. A recommendation device based on the recognition of face and style, comprising:
a face recognition unit configured to extract face feature information from a user image transmitted from a user terminal and recognize face characteristics using the extracted face feature information, or recognize the face characteristics using face feature information transmitted from the user terminal;
a style recognition unit configured to extract style feature information from the user image transmitted from the user terminal and recognize style characteristics using the extracted style feature information, or recognize the style characteristics using style feature information transmitted from the user terminal; and
a recommendation unit configured to search recommendation style information matched with the recognized face and style characteristics in a recommendation style table in which recommendation style information is templated according to face and style characteristics to transmit the searched recommendation style information to the user terminal.

3. The recommendation device of claim 2, wherein the recommendation unit transmits the recommendation style information including at least one of hair style information, makeup style information, and recommendation product information to the user terminal.

4. The recommendation device of claim 2, further comprising:
a templating unit configured to separate recommendation style information matched with collected characteristics and style characteristics and template the recommendation style information according to the characteristics based on the separated result to generate the recommendation style table.

5. The recommendation device of claim 2, further comprising:
a face DB configured to store the face feature information and the recognized face characteristics;
a style DB configured to store the style feature information and the recognized style characteristics;
a hair DB configured to store hair style information matched with the recognized face and style characteristics;
a makeup DB configured to store makeup style information matched with the recognized face and style characteristics; and
a product DB configured to store recommendation product information matched with the recognized face and style characteristics.

6. The recommendation device of claim 2, wherein the face recognition unit recognizes gender and age of the user as the face characteristics from at least one of a mouth shape, an eye shape, a nose shape, a middle of the forehead, skin color, wrinkle information, and a forehead width of the extracted face feature information.

7. The recommendation device of claim 2, wherein the style recognition unit recognizes the style characteristics of the user from at least one of apparel pattern information, color information, season information, weather information of the extracted style feature information.

8. The recommendation device of claim 2, wherein when the recognized style characteristics are changed by the user terminal or new style characteristics are added thereto, the recommendation unit researches recommendation style information matched with the changed or added style characteristics to transmit the researched recommendation style information to the user terminal.

9. The recommendation device of claim 2, wherein when a plurality of recommendation style information is searched, the recommendation unit prioritizes the plurality of searched recommendation style information according to a matched ratio with the recognized characteristics and style characteristics to transmit it to the user terminal.

10. A product recommendation method based on the recognition of face and style, comprising:
an information extracting step of extracting face and style feature information from a user image;
a face recognizing step of recognizing face characteristics using the extracted face feature information;
a style recognizing step of recognizing style characteristics using the extracted style feature information; and
a style recommending step of searching recommendation style information matched with the recognized face and style characteristics in a recommendation style table in which recommendation style information is templated according to characteristics to transmit the searched recommendation style information to a user terminal.

11. The product recommendation method of claim 10, wherein in the style recommending step, at least one of hair style information, makeup style information, and recommendation product information is included in the recommendation style information to thereby be transmitted to the user terminal.

12. The product recommendation method of claim 10, further comprising:
a recommendation product templating step of separating recommendation style information matched with collected characteristics and style characteristics and templating the recommendation style information according to the characteristics by the separated result to generate the recommendation style table.

13. The product recommendation method of claim 10, wherein in the face recognizing step, gender and age of the user are recognized as face characteristics from at least one of a mouse shape, an eye shape, a nose shape, a middle of a forehead, a skin color, wrinkle information, a forehead width of the extracted face feature information.

14. The product recommendation method of claim 10, wherein in the style recognizing step, the style characteristics of the user are recognized from at least one of apparel pattern information, color information, season information, and weather information of the extracted style feature information.

15. The product recommendation method of claim 10, wherein in the style recommending step, when the recognized style characteristics are changed or the style characteristics are added by the user terminal, recommendation style information matched with the changed or added style characteristics is researched to thereby be transmitted to the user terminal.

16. The product recommendation method of claim 10, wherein in the style recommending step, when a plurality of recommendation style information is searched, the plurality of searched recommendation style information is prioritized according to a matched ratio with the recognized characteristics and style characteristics to thereby be transmitted to the user terminal.
